(19) United States
(12) Patent Application Publication
(10) Pub. No.: US 2014/0209576 A1
(43) Pub. Date: Jul. 31, 2014

(54) USE OF ELEVATED PRESSURES FOR REDUCING CRACKS IN SUPERALLOY WELDING AND CLADDING

(71) Applicants: Kazim Ozbaysal, Orlando, FL (US); Zafir A. M. Abdo, Orlando, FL (US)

(72) Inventors: Kazim Ozbaysal, Orlando, FL (US); Zafir A. M. Abdo, Orlando, FL (US)

(21) Appl. No.: 13/754,967

(22) Filed: Jan. 31, 2013

(51) Int. Cl. B23K 26/34

(52) U.S. Cl. CPC B23K 26/345
USPC 219/121.64; 219/121.63; 219/137 R

(57) ABSTRACT

A superalloy component, such as gas turbine blade or vane, is structurally welded by placing the component in an isolation chamber. Inert gas is introduced into the chamber. The substrate is welded in the chamber, creating a weld zone. Pressure is applied directly on the weld zone that is greater than atmospheric pressure. Application of such pressure increases the weld zone ductility and reduces likelihood of solidification cracking and strain age cracking, compared to weld zones formed at atmospheric pressure. In some embodiments an isostatic pressure chamber is used to apply isostatic pressure on the weld zone. In other embodiments the welding is performed by laser welding or cladding, TIG welding electron beam welding or autogenous welding.

### CROSS-REFERENCE TO RELATED APPLICATIONS

This application incorporates by reference in its entirety commonly owned, co-pending United States Utility patent application entitled “SUPERALLOY LASER CLADDING WITH SURFACE TOPOLOGY ENERGY TRANSFER COMPENSATION” filed Sep. 12, 2012 and assigned Ser. No. 13/611,034.

### BACKGROUND OF THE INVENTION

1. Field of the Invention

The invention relates to methods and apparatus for welding and cladding superalloy materials, typically components such as service-degraded turbine blades and vanes, while reducing or avoiding cracking of the material and improving its ductility. More particularly, the present invention relates to method and apparatus for welding or clading high γ′ Ni based superalloys with a reduction or avoidance of cracking and an improved ductility by the application of elevated pressure.

2. Description of the Prior Art

“Structural” repair of gas turbine or other superalloy components is commonly recognized as replacing damaged material with matching alloy material and achieving properties, such as strength, that are close to the original manufacture component specifications (e.g., at least seventy percent ultimate tensile strength of the original specification). For example, it is preferable to perform structural repairs on turbine blades that have experienced surface cracks, so that risk of further cracking is reduced, and the blades are restored to original material structural and dimensional specifications.

Structural repair of high γ′ nickel based superalloy material that is used to manufacture turbine components, such as turbine blades, is challenging, due to the metallurgic properties of the finished blade material. Superalloys, such as N5, CM247, MARM002, IN738, among others, are often used in gas turbine applications, due to their good high temperature environment and mechanical properties. The aluminum and titanium content of the superalloys, such as N5 and CM247 (among others) are increased to obtain higher mechanical strength and heat resistance properties, and the finished turbine blade alloys are typically further strengthened during post casting heat treatments. A superalloy having more than about 6% aggregate aluminum or titanium content, such as CM247 or N5 alloy, is more susceptible to strain age cracking when subjected to high-temperature welding than a lower aluminum-titanium content superalloy such as X-750. The weldability and reparability of these superalloy materials is decreased due to hot cracking, grain boundary embrittlement, solidification cracking and strain age cracking. These N5 and CM247 superalloy materials possess a “zero ductility range” when cooled from weld temperature. Most of the cracking occurs in the “zero ductility range”. Due to the loss of ductility, CM247 and N5 superalloy components cannot be structurally repaired to achieve the desired 70% or greater original specification tensile strength by traditional welding processes with commercially acceptable repair yield results.

Traditional welding processes for superalloy fabrication or repair generally involve substantial melting of the substrate adjoining the weld preparation, and complete melting of the welding rod or other filler material added. When a blade constructed of such a material is welded with filler metal of the same or similar alloy, the blade is susceptible to solidification cracking (aka liquation cracking) within and proximate to the weld, and/or strain age cracking (aka reheat cracking) during subsequent heat treatment processes intended to restore the superalloy original strength and other material properties to those comparable to a new component. Low successful structural repair yield rates by traditional welding processes make it commercially cheaper to scrap cracked blades and vanes that need structural repair rather than waste effort to repair them.

As an alternative to traditional superalloy component turbine blade and vane structural welding processes, another known superalloy joining and repair method that attempts to melt superalloy filler material without thermally degrading the underlying superalloy substrate is laser beam welding, also known as laser beam micro cladding or selective laser melting (SLM). Superalloy filler material (often powdered filler) compatible with or identical to the superalloy substrate material is pre-positioned on a substrate surface or sprayed on the surface during the cladding process. A “spot” area of focused laser optical energy generated by a fixed-optic laser (i.e., other than relative translation, laser and substrate have a fixed relative orientation during laser beam application) liquefies the filler material and heats the substrate surface sufficiently to facilitate good coalescence of the filler and substrate material, that subsequently solidify as a clad deposit layer on the substrate surface. Compared to other known traditional welding or cladding processes, laser beam micro-cladding is a lower heat input process, with relatively good control over melting of the substrate and rapid solidification that reduce propensity to cause previously-described solidification cracking. Lower heat input to the superalloy substrate during laser welding/cladding also reduces residual stresses that otherwise would be susceptible to previously described post-weld heat treatment strain age cracking. While laser cladding welds have structural advantages over traditionally-formed welds, practical manufacturing and repair realities require larger cladding surface area and/or volume coverage than can be filled by a single-pass applied cladding deposit.

In the previously identified, incorporated by reference, copending application Ser. No. 13/611,034, a superalloy substrate, such as a turbine blade or vane, is fabricated or repaired by laser beam welding to clad one or more layers on the substrate. Laser optical energy is transferred to the welding filler material and underlying substrate to assure filler melting and adequate substrate surface wetting for good fusion. Energy transfer is maintained below a level that threatens thermal degradation of the substrate. Optical energy transfer to the filler and substrate is maintained uniformly as the laser beam and substrate are moved relative to each other along a translation path by varying the energy transfer rate to compensate for localized substrate topology variations.

Thus, a need exists for welding/cladding processes, materials and apparatus for welding/cladding superalloys with reduced occurrence of cracking, either during the welding/cladding process or during post-processing heat treatment.

### SUMMARY OF THE INVENTION

The present invention relates generally to welding/cladding a superalloy component, such as a gas turbine blade or vane, with the application of elevated pressure. Some embodiments relate to laser welding/cladding in an isostatic pressure chamber in an intet gas atmosphere with pressure applied during the welding/cladding process as well as during the subsequent cooling. The applied isostatic pressure inhibits cracking during welding/cladding and subsequent cooling, apparently by the mechanism of compressing the component and its weld zone to counteract tensile stresses developing in the weld zone. Preferably, sufficient isostatic pressure is applied to increase weld zone ductility to be greater than ductility of a comparable weld zone formed at atmospheric pressure.

An exemplary embodiment method for cladding superalloy components features placing a superalloy component substrate in an isostatic pressure chamber. Filler material, which may comprise the same superalloy material as the component, is typically introduced on the substrate surface. Inert gas is introduced into the pressure chamber. Isostatic pressure is applied in the pressure chamber on the filler material and substrate that is greater than atmospheric pressure. A laser beam is focused on the filler material and substrate. The laser transfers optical energy to the filler material and substrate in a weld zone that fuses the filler material to the substrate. In some embodiments sufficient isostatic pressure is applied to increase weld zone ductility compared to fusion at atmospheric pressure. Isostatic pressure up to 100 ksi (689.4 kPa) may be applied in the pressure chamber. In some embodiments the inert gas comprises argon or nitrogen. The pressure chamber may be heated before fusing the filler material to the substrate. In some embodiments the substrate and laser beam are moved relative to each other to form a multi-dimensional weld zone.

Other embodiments include welding without the addition of filler material, or autogenous welding as well as other means for the application of pressure. Pressure may be applied during or immediately after the welding process.

Another exemplary embodiment features a turbine component selected from the group consisting of turbine blades and turbine vanes, having a superalloy substrate and crack-free weld zone having a first ductility by placing a superalloy component substrate in an isostatic pressure chamber, introducing superalloy filler material on a component superalloy substrate surface and introducing inert gas in the pressure chamber. Isostatic pressure is applied in the pressure chamber on the superalloy filler material and substrate that is greater than atmospheric pressure. A laser beam is focused on the filler material and substrate. Optical energy from the laser beam is transferred to the superalloy filler material and substrate in a weld zone that fuses the filler material to the substrate in the weld zone. In some embodiments, the applied isostatic pressure causes the first ductility to be greater than ductility of a weld zone formed at atmospheric pressure. Isostatic pressure up to 100 ksi (689.4 kPa) may be applied in the pressure chamber. The pressure chamber may be heated before fusing the filler material to the substrate. In some embodiments the inert gas comprises argon or nitrogen. In some embodiments the substrate and laser beam are moved relative to each other to form a multi-dimensional weld zone.

Another exemplary embodiment features a system for cladding turbine superalloy components with a superalloy filler layer. A laser generates a laser beam for transferring optical energy to a turbine component superalloy substrate and superalloy filler material on the substrate that fuses the filler material to the substrate in a weld zone, forming the filler layer. The system also has an isostatic pressure chamber for retaining inert gas, the substrate and filler material, and for generating isostatic pressure that is greater than atmospheric pressure during weld zone formation. In some embodiments the pressure chamber has a sealed window for transmitting the laser beam there through from outside the chamber to inside the chamber. In some embodiments the pressure chamber is a heated pressure chamber and/or is capable of applying isostatic pressure up to 100 ksi (689.4 kPa). In some embodiments the system also has a motion control system for moving the substrate and laser beam relative to each other to form a multi-dimensional weld zone. The motion control system may comprise at least one movable mirror intercepting the laser beam, for orienting the laser beam on the substrate; and at least one drive system coupled to each of the respective at least one movable mirror and the laser for causing relative motion between the laser beam and substrate, and for maintaining uniform energy transfer to the substrate. The laser and motion control system may comprise a galvanometer scanner

The features of the present invention may be applied jointly or severally in any combination or sub-combination by those skilled in the art.

### BRIEF DESCRIPTION OF THE DRAWINGS

The teachings of the present invention can be readily understood by considering the following detailed description in conjunction with the accompanying drawings, in which:

FIG. 1 shows a schematic perspective view of a first exemplary embodiment of an isostatic pressure welding apparatus of the present invention;

FIG. 2 shows a schematic perspective view of a second exemplary embodiment of an isostatic pressure welding apparatus of the present invention;

FIG. 3 shows a schematic perspective view of a third exemplary embodiment of an isostatic pressure welding apparatus of the present invention; and

FIG. 4 shows a schematic perspective view of a fourth exemplary embodiment of an isostatic pressure welding apparatus of the present invention.

To facilitate understanding, identical reference numerals have been used, where possible, to designate identical elements that are common to the figures.

### DETAILED DESCRIPTION

After considering the following description, those skilled in the art will clearly realize that the teachings of the present invention can be readily utilized in welding/clading of superalloy components, such as gas turbine blades and vanes, including structural welding of such superalloy components. Some embodiments of the present invention elate to an isostatic pressure laser welding apparatus and method to facilitate crack-free structural welding of superalloy components with superalloy filler material. The apparatus and method embodiments of the present invention inhibit solidification and post-weld heat treatment cracking of the superalloy components in the weld zone.

As previously noted, as the aluminum and titanium content of the superalloys is increased to obtain better mechanical properties; their weldability and reparability is decreased due to hot cracking, grain boundary embrittlement, solidification cracking and strain age cracking. Crack formation in materials is attributable to void formation or interface opening under tensile stress. Low ductility in a material renders it more susceptible to crack formation. Turbine blade and vane components formed from superalloys, such as N5 and CM247, possess a “ductility dip range”. when a weld zone therein is cooled from weld temperature. Most of the cracking occurs in the zero or low ductility weld zone. Generally, a material's ductility can be increased by applying hydrostatic pressure on the material. By applying isostatic pressure to the material, ductility can be increased threefold compared to ductility at atmospheric pressure. As noted, crack formation in materials is attributable to void formation or interface opening under tensile stress. Application of a compressive hydrostatic pressure on the material counteracts the tensile stress and reduces likelihood of crack formation. Thus application of compressive hydrostatic pressure, such as isostatic pressure, provides a dual benefit of counteracting tensile stresses that promote crack formation and increasing the material ductility (i.e., decreasing crack formation susceptibility). Ductility increase does not negatively impact material strength as strength is not affected by hydrostatic/isostatic pressure.

In situ compressive stresses are applied on superalloy component weldments during or immediately after welding and while cooling from welding temperature, in order to inhibit microcracking in the weld zone and enhance weld zone ductility. The compressive stresses are advantageously applied in isostatic pressure chambers, however pressure applied by means of direct contact loads during welding can also be employed. Thus the external pressure application at levels greater than atmospheric pressure inhibits void formation and crack opening during welding and cooling, while providing additional benefit of increasing weld zone ductility. As described in greater detail below, embodiments utilize laser welding in a hydrostatic and/or isostatic pressure chamber to achieve crack-free superalloy laser structural weld build up, laser cladding and welding. Laser heating of the substrate and filler material is conducted under inert gas atmosphere at a maximum pressure of approximately 100 ksi (689.4 kPa). The pressure chamber may be heated depending on the alloy type further to improve material ductility.

To be concrete in our description, we focus on the particular embodiments using laser welding/cladding , including a filler material, and isostatic application of pressure. Other embodiments within the scope of the present invention include other means for the application of pressure, such as direct contact loading, peening, and rolling. In other embodiments there is an absence of filler material in autogeneous welding processes. Other types of welding processes are used in other embodiments, such as electron beam welding or Tungsten-Inert-Gas (TIG) welding.

Furthermore, our focus herein is on the description of laser welding processes, but the present invention is not limited to typical welding. Surface cladding with the addition of powder, sheet or foil cladding materials are included within the scope of this invention as would be apparent to those having ordinary skills in the art.

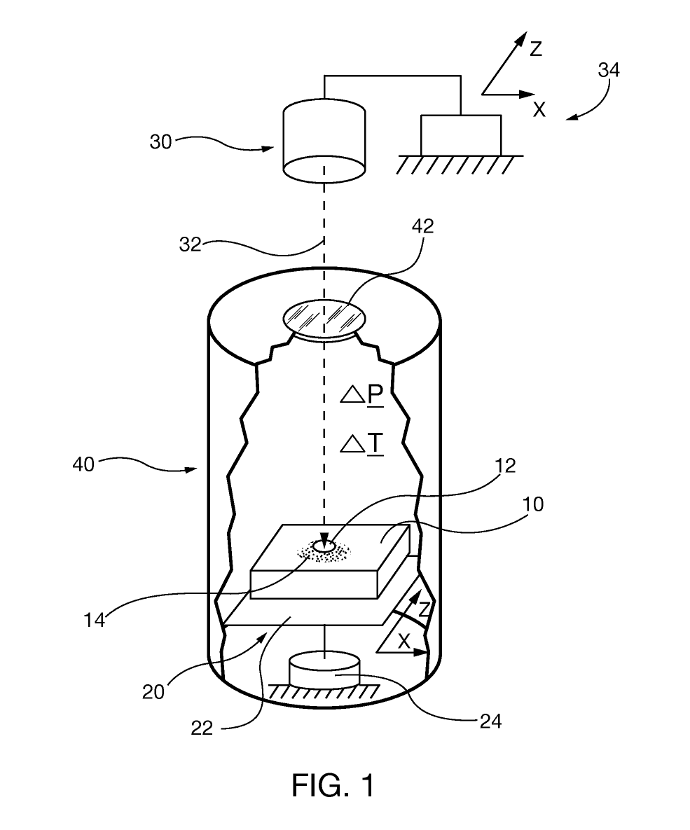

A first embodiment of the present invention is shown in FIG. 1. A superalloy component substrate 10, such as a turbine blade or vane, has a weld zone 12 formed by the heating of the substrate and filler material 14. Often the filler material 14 is applied to the component substrate 10 prior to commencement of the welding operation. Alternatively filler material 14 may be applied with a filler spreader solely or in conjunction with pre-applied filler, using known application techniques. The filler material 14 may comprise powdered superalloy material, and may comprise the same material as the component substrate 10. Weld zones 12 that are formed with superalloy filler material 14 may constitute structural welds of the component substrate 10. The component substrate 10 is placed on a work piece fixture system 20 that optionally may include a work table 22 and motion control system 24 for imparting desired relative motion between the substrate 10 and a laser welding apparatus 30. The laser welding apparatus 30 focuses a laser beam 32 on the filler material 14 and substrate 10, transferring optical energy to both, and forming the weld zone 12 that fuses the filler material to the substrate. Optionally the laser welding apparatus 30 includes a motion control system 34 for imparting desired relative motion between the substrate 10 and the laser beam 32. Relative motion between the laser beam 32 and the substrate 10 forms a multi-dimensional weld zone.

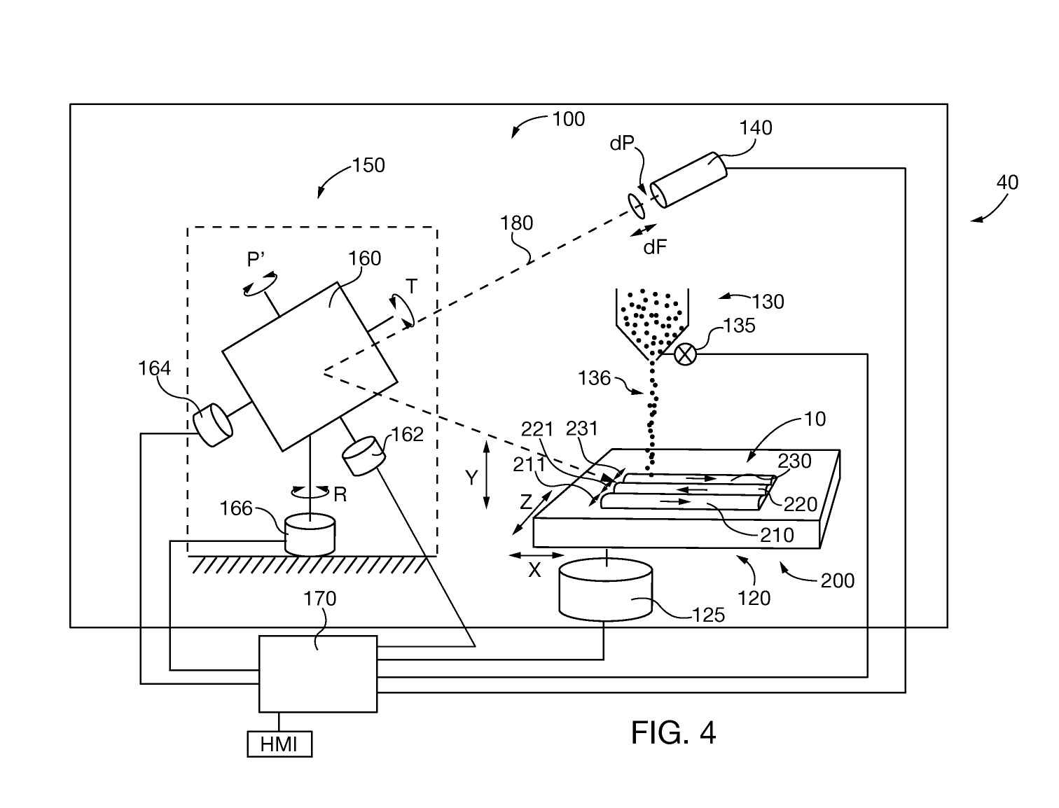

Optionally, a control system can be included (170 in FIG. 4) for changing the characteristics of the delivered laser energy during processing. Typically, the laser energy and/or spot size may be altered during processing to adjust for changing contours of the component substrate 10, changing applied pressure, among other factors.

The superalloy component substrate 10 and the filler material 14 are placed and retained within an isostatic pressure chamber 40 in an inert gas environment. Suitable inert gasses include argon and nitrogen. Isostatic pressure is applied in the pressure chamber 40 prior to commencement of welding through component cooling. Pressure level ΔP is applied within the pressure chamber 40 at a sufficient level greater than atmospheric pressure to inhibit formation of cracks in the weld zone 12 and desirably may be applied at a sufficient level to increase ductility of the component weld zone and component substrate 10, up to approximately 100 ksi (689.4 kPa). The pressure chamber 40 may be heated to a temperature ΔT (below the lower of the component 10 or filler material 14 solution temperatures), depending on the alloy type , further to improve substrate 10 and weld zone 12 material ductility. State variables (temperature ΔT and pressure ΔP) are desirably used in conjunction with laser welding to increase the weld zone 12 and/or component substrate 10 material ductility from a “zero ductility range” to a weldable ductility range.

Laser beam transparent window 42 allows laser light transmission and is incorporated in the pressure chamber 40. The window 42 may be constructed with a single crystal sapphire (AI203). Sapphire is anisotropic and has hexagonal closed packed crystalline structure. The orientation of sapphire window 42 to the laser beam 32 is either parallel or perpendicular to its crystalline “c” axis. Any window with sufficient mechanical properties may be substituted for one constructed of sapphire. Location of window 42 is variable. It can be located at the bottom of the chamber 40 and the laser beam 32 can be directed with optical mirrors to the weld.

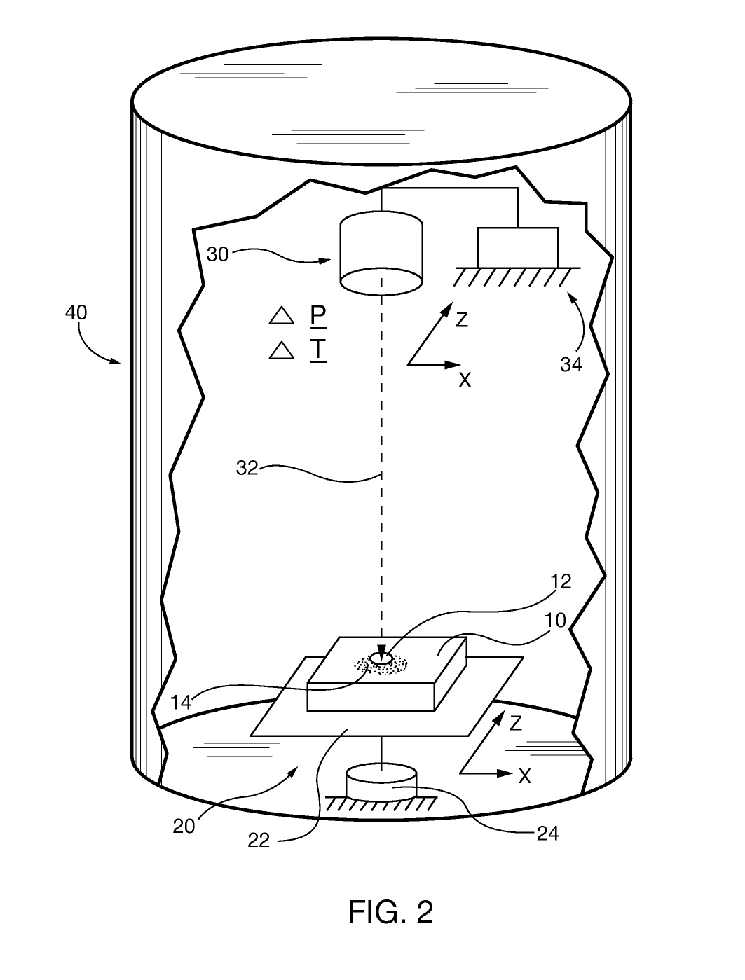

In the embodiment of FIG. 2 the laser welding apparatus 30 is retained within the pressure chamber 40, eliminating the need for a transparent window. Otherwise the embodiments of FIGS. 1 and 2 have the same types of components and operation.

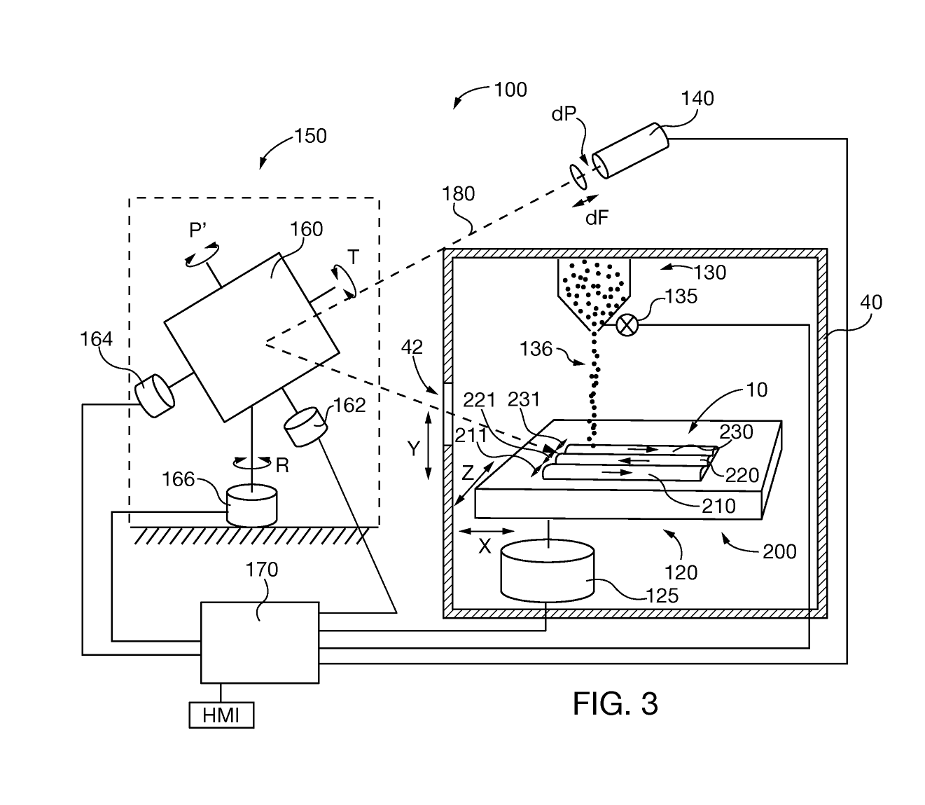

FIGS. 3 and 4 are respective additional embodiments corresponding to those of FIGS. 1 and 2, that incorporate the multi-dimensional surface topology laser welding apparatus and methods of the commonly owned, incorporated by reference U.S. application Ser. No. 13/611,034 for the work piece fixture system 20 and laser welding apparatus 30 of FIGS. 1 and 2. In FIG. 3 the laser is oriented outside the pressure chamber 40 and the laser beam is transmitted through the window 42. Conversely in FIG. 4 the laser is oriented within the pressure chamber 40.

With reference to either of FIG. 3 or 4, laser welding/cladding system 100 includes a work table 120 to which is affixed a work piece such as turbine blade 10. Optional work table motion control system 125 is used to move the work table 120 in the X, Y and Z coordinates shown or in any other single- or multi-axis coordinate system. A known powdered filler hopper 130 with application valve 135 introduces powdered filler material 136 to the turbine blade 10 substrate surfaces. The powder filler may have its own independent motion control system for moving the poured powder 136 application zones relative to the blade 10 substrate. Powdered filler material 136 may be fed to the fixed point of beam focus, as shown, off-axis powder feeders can spray filler powder over the full translational range of laser beam scanning, and elongated powder feeder nozzles can be employed. Powder 136 may also be pre-placed on the substrate 10 before the laser welding process is initiated. Solid wire or strip filler may be substituted for powder filler material 136.

The system 100 has a laser 140 with optional variable focus dF or power output dP that provides the laser beam optical energy source for heating the substrate 10 and filler material 136. The system 100 also has a moveable mirror system 150 with mirror 160 that is capable of single- or multi-axis movement, shown as tilt T, pan P and rotate R axes under control of respective drives 162, 164 and 166. The drives 162, 164 and 166 may be part of a known construction motorized motion control system or incorporated in a known galvanometer, that are under control of known controller 170.

Alternately the beam may be intercepted by multiple mirrors with single (or multiple) axes of motion to achieve each of the afore-described axes movements.

The controller 170 may be a stand-alone controller, programmable logic controller or personal computer. The controller 170 may also control one or more of the work table motion control system 125, the powdered filler material hopper valve 135 and/or the optional hopper motion control system (not shown), and/or the laser 140 variable focus dF and/or power output dP. Known open and/or closed feedback loops with the controller may be associated with one or more of the drives 125, 135, 162-166, dF, dP, and the hopper position drive. Laser beam optical energy transfer to the substrate and filler can also be monitored in a closed feedback loop so that the controller can vary the energy transfer rate based on the monitored energy transfer rate. A human machine interface (HMI) may be coupled to the controller 170 for monitoring welding operations and/or providing instructions for performing a welding operation.

When operating the welding system 100 the output beam 180 of the laser 140 is reflected off mirror 160 (or multiple mirrors) and in turn on to the turbine blade 10 work piece, which transfers optical energy to the turbine blade 10 and filler material 136. Both the turbine blade substrate 10 and filler material 136 absorb the transferred optical energy, to melt the filler material, wet the substrate surface and fuse the melted filler and substrate surface to each other. The substrate 10 and laser beam 180 are moved relative to each other along a translation path by the control system engagement of the work table drive system 125 and/or the moveable mirror system 150 drives 162, 164, 166 to form a continuous welded cladding layer 200. When the movable mirror system 150 is incorporated in a commercially available laser galvanometer system, relative motion between the substrate 10 and the laser beam 180 as well as the laser optical energy transfer rate can be varied by moving the galvanometer mirror 160 (or multiple mirrors) for both relative translation and oscillation. Relative motion between the laser beam 180 and the substrate 10/filler material 136 maintains a continuous melted weld line at the leading edge of translation motion (e.g., the right leading edge of the weld line in FIGS. 3 or 4) for fusion uniformity that is not possible with known unoscillated laser cladding systems.

The laser optical energy absorbed at any beam focus area varies proportionately with focus time duration. By non-limiting example laser beam 180 focus time duration and proportional absorbed energy can be varied in the following ways: (i) the laser beam 180 can be oscillated parallel to or side-to-side transverse (e.g., 211) the weld translation path 210; (ii) the oscillation or translation speed can be varied; and (iii) the laser power intensity dP or focus dF can be varied continuously or by pulse modulation. Thus by dynamically varying changing the rate of laser beam focus time duration the energy transfer rate to the substrate and filler is varied along the weld line translation path, so that uniform energy transfer is maintained within the entire weld, regardless of local topography variations.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

What is claimed is:

1. A method for cladding superalloy components, comprising:
placing a superalloy component substrate in an isostatic pressure chamber;
introducing filler material on the substrate surface introducing inert gas in the pressure chamber;
applying isostatic pressure in the pressure chamber on the filler material and substrate that is greater than atmospheric pressure;
focusing a laser beam on the filler material and substrate; and
transferring optical energy from the laser to the filler material and substrate in a weld zone that fuses the filler material to the substrate.

2. The method of claim 1 further comprising applying isostatic pressure up to 100 ksi (689.4 kPa) in the pressure chamber.

3. The method of claim 1 further comprising heating the isostatic pressure chamber before fusing the filler material to the substrate.

4. The method of claim 3 further comprising applying isostatic pressure up to 100 ksi (689.4 kPa) in the pressure chamber.

5. The method of claim 4 further comprising moving the substrate and laser beam relative to each other to form a multi-dimensional weld zone.

6. The method of claim 1, the inert gas selected from the group consisting of argon and nitrogen.

7. The method of claim 1 comprising applying isostatic pressure to increase weld zone ductility compared to fusion at atmospheric pressure.

8. The method of claim 7 further comprising applying isostatic pressure in the pressure chamber with an inert gas selected from the group consisting of argon and nitrogen, and moving the substrate and laser beam relative to each other to form a multi-dimensional weld zone.

9. The method of claim 1 further comprising moving the substrate and laser beam relative to each other to form a multi-dimensional weld zone.

10. A turbine component selected from the group consisting of turbine blades and turbine vanes, having a superalloy substrate and crack-free weld zone having a first ductility by:
placing a superalloy component substrate in an isostatic pressure chamber;
introducing superalloy filler material on a component superalloy substrate surface;
introducing inert gas in the pressure chamber;
applying isostatic pressure in the pressure chamber on the superalloy filler material and substrate that is greater than atmospheric pressure;
focusing a laser beam on the filler material and substrate;
transferring optical energy with the laser to the superalloy filler material and substrate in a weld zone that fuses the filler material to the substrate in the weld zone.

11. The component of claim 10, the applied isostatic pressure causing the first ductility to be greater than ductility of a weld zone formed at atmospheric pressure.

12. The component of claim 10, further comprising applying isostatic pressure up to 100 ksi (689.4 kPa) in the pressure chamber.

13. The component of claim 10, further comprising heating the isostatic pressure chamber before fusing the filler material to the substrate.

14. The component of claim 10, further comprising applying isostatic pressure in the pressure chamber with an inert gas.

15. The component of claim 10, comprising a weld zone formed by moving the substrate and laser beam relative to each other while maintaining uniform energy transfer.

16. A system for cladding turbine superalloy components with a superalloy filler layer, comprising:
a laser generating a laser beam for transferring optical energy to a turbine component superalloy substrate and superalloy filler material on the substrate that fuses the filler material to the substrate in a weld zone, forming a superalloy filler layer; and
an isostatic pressure chamber for retaining inert gas, the substrate and filler material, for generating isostatic pressure that is greater than atmospheric pressure during weld zone formation.

17. The system of claim 16, the pressure chamber having a sealed window for transmitting the laser beam therethrough.

18. The system of claim 16, the pressure chamber further comprising a heated pressure chamber.

19. The system of claim 16, the pressure chamber capable of applying isostatic pressure up to 100 ksi (689.4 kPa).

20. The system of claim 16, further comprising a motion control system for moving the substrate and laser beam relative to each other to form a multi-dimensional weld zone.

21. The system of claim 20, the motion control system comprising:
at least one movable mirror intercepting the laser beam, for orienting the laser beam on the substrate; and
at least one drive system coupled to each of the respective at least one movable mirror and the laser for causing relative motion between the laser beam and substrate, and for maintaining uniform energy transfer to the substrate.

22. The system of claim 21, the laser and motion control system comprising a galvanometer scanner.

23. A method for welding superalloy components, comprising:
placing a superalloy component substrate in an isolation chamber;
introducing inert gas in the chamber;
welding the substrate in the chamber and creating a weld zone;
applying pressure directly on the weld zone that is greater than atmospheric pressure.

24. The method of claim 23, the welding step selected from the group consisting of laser cladding, laser welding, autogenous welding, electron beam welding and tungsten inert gas welding.

25. The method of claim 23, the pressure applying step being initiated during the welding step.

26. The method of claim 23, the pressure applying step being initiated after the welding step during a weld cooling step.
